(19) United States
(12) Patent Application Publication
(10) Pub. No.: US 2012/0303452 A1
(43) Pub. Date: Nov. 29, 2012

(54) Method and Apparatus for Providing Context Attributes and Informational Links for Media Data

(75) Inventors: Wenwei Xue, Beijing (CN); Zhanjiang Song, Beijing (CN); Dong Liu, Beijing (CN); Jilei Tian, Beijing (CN); Yiming Ma, Fremont, CA (US)

(73) Assignee: NOKIA CORPORATION, Espoo (FI)

(21) Appl. No.: 13/576,755

(22) PCT Filed: Feb. 3, 2010
(86) PCT No.: PCT/CN2010/070484

§ 371 Date: Aug. 13, 2012

(51) Int. Cl. G06F 3/01; G06F 15/16; G06Q 30/02

(52) U.S. Cl. 705/14.49; 715/748

(57) ABSTRACT

Various embodiments include a method including receiving media data on an apparatus, and receiving one or more context attributes related to the apparatus or accessed by the apparatus. The method further includes determining whether the one or more context attributes relate to the media data, and causing, at least in part, display of the media data with the one or more context attributes that are determined to relate to the media data. Also, a method is provided that includes receiving media data on an apparatus, parsing the media data into one or more structured elements, determining one or more informational links that relate to the one or more structured elements of the media data, and causing, at least in part, display of the media data with the one or more informational links that are determined to relate to the one or more structured elements.

### BACKGROUND

Service providers and device manufacturers are continually challenged to deliver value and convenience to consumers by, for example, providing compelling services and vast array of media and products. Service providers can provide various user interface applications for use on user equipment that enhance the user's interface experience with the user equipment and utilization of the various products and services offered by the service provider. While many devices offered today provide a user with the capability of communicating with other users and accessing various products and services, such devices either do not have the capability or have limited ability to provide a user with customized interactions with the device and services provided via the device. While current devices are privy to large amounts of contextual information about the user of the device, such devices do not utilize such contextual information in a manner that is useful to the user or in a manner that accentuates the services provided by service providers. Currently available user interface applications have clear limitations in their ability to utilize the vast amount of information passing therethrough, and thus fail to provide the user with an interface that can allow for the user to fully appreciate and utilize the various products and services offered by the service provider.

### SOME EXAMPLE EMBODIMENTS

Therefore, there is a need for an approach for providing context attributes and informational links for media data.

According to one embodiment, a method comprises receiving media data on an apparatus, and receiving one or more context attributes related to the apparatus or accessed by the apparatus. The method further comprises determining whether the one or more context attributes relate to the media data, and causing, at least in part, display of the media data with the one or more context attributes that are determined to relate to the media data.

According to another embodiment, an apparatus comprising at least one processor, and at least one memory including computer program code, the at least one memory and the computer program code configured to, with the at least one processor, cause the apparatus to perform at least the following: receive media data on the apparatus; receive one or more context attributes related to the apparatus or accessed by the apparatus; determine whether the one or more context attributes relate to the media data; and cause, at least in part, display of the media data with the one or more context attributes that are determined to relate to the media data.

According to another embodiment, a computer-readable storage medium carrying one or more sequences of one or more instructions which, when executed by one or more processors, cause an apparatus to at least perform the following steps: receiving media data on an apparatus; receiving one or more context attributes related to the apparatus or accessed by the apparatus; determining whether the one or more context attributes relate to the media data; and causing, at least in part, display of the media data with the one or more context attributes that are determined to relate to the media data.

According to another embodiment, an apparatus comprises means for receiving media data on an apparatus, and means for receiving one or more context attributes related to the apparatus or accessed by the apparatus. The apparatus further comprises means for determining whether the one or more context attributes relate to the media data, and means for causing, at least in part, display of the media data with the one or more context attributes that are determined to relate to the media data.

According to another embodiment, a method comprises receiving media data on an apparatus, parsing the media data into one or more structured elements, determining one or more informational links that relate to the one or more structured elements of the media data, and causing, at least in part, display of the media data with the one or more informational links that are determined to relate to the one or more structured elements.

According to another embodiment, an apparatus comprises: at least one processor; and at least one memory including computer program code, the at least one memory and the computer program code configured to, with the at least one processor, cause the apparatus to perform at least the following, receive media data on the apparatus; parse the media data into one or more structured elements; determine one or more informational links that relate to the one or more structured elements of the media data; and cause, at least in part, display of the media data with the one or more informational links that are determined to relate to the one or more structured elements.

According to another embodiment, a computer-readable storage medium carrying one or more sequences of one or more instructions which, when executed by one or more processors, cause an apparatus to at least perform the following steps: receiving media data on an apparatus; parsing the media data into one or more structured elements; determining one or more informational links that relate to the one or more structured elements of the media data; and causing, at least in part, display of the media data with the one or more informational links that are determined to relate to the one or more structured elements.

According to another embodiment, an apparatus comprises means for receiving media data on an apparatus, means for parsing the media data into one or more structured elements, means for determining one or more informational links that relate to the one or more structured elements of the media data, and means for causing, at least in part, display of the media data with the one or more informational links that are determined to relate to the one or more structured elements.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of providing context attributes and informational links for media data, according to one embodiment;

FIG. 2 is a diagram of the components of user equipment including a user interface widget capable of providing context attributes and informational links for media data, according to one embodiment;

FIG. 3A is a flowchart of a process for causing display of media data with related context attributes, according to one embodiment;

FIG. 3B is a flowchart of a process for causing display of highlighted keywords and/or keyphrases and causing display of context attributes upon selection of the highlighted display, according to one embodiment;

FIGS. 4A-4E are diagrams of user interfaces utilized in the processes of FIGS. 3A and 3B, according to various embodiments;

FIGS. 5A and 5B are diagrams of user interfaces utilized in the processes of FIGS. 3A and 3B, according to various embodiments;

FIG. 6 is a flowchart of a process for causing display of media data with informational links related to structured elements of the media data, according to one embodiment;

FIG. 7 is a diagram of a user interface utilized in the process of FIG. 6, according to various embodiments;

FIGS. 8A-8C are diagrams of user interfaces utilized in the process of FIG. 6, where FIG. 8B is shown on a mobile device, according to various embodiments;

FIG. 9 is a diagram of hardware that can be used to implement an embodiment of the invention;

FIG. 10 is a diagram of a chip set that can be used to implement an embodiment of the invention; and

FIG. 11 is a diagram of a mobile terminal (e.g., handset) that can be used to implement an embodiment of the invention.

### DESCRIPTION OF SOME EMBODIMENTS

Examples of a method, apparatus, and computer program for providing context attributes and informational links for media data are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

Although various embodiments are described with respect to mobile communication devices, it is contemplated that the approach described herein may be used with other user equipment, as noted in greater detail below.

Various embodiments described herein provide context attributes and informational links for media data. The media data can include content data and metadata. For example, the media data can include any type of (multi)media content such as textual data, texts, images, audio, video, any combination of multiple types of content, etc., and metadata of the content data, such as a set of textual descriptions that express the semantic meanings of the content data. Such metadata can be obtained from the content data through various state-of-the-art techniques, such as natural language processing (NLP), speech recognition, image/video content analysis, and so on.

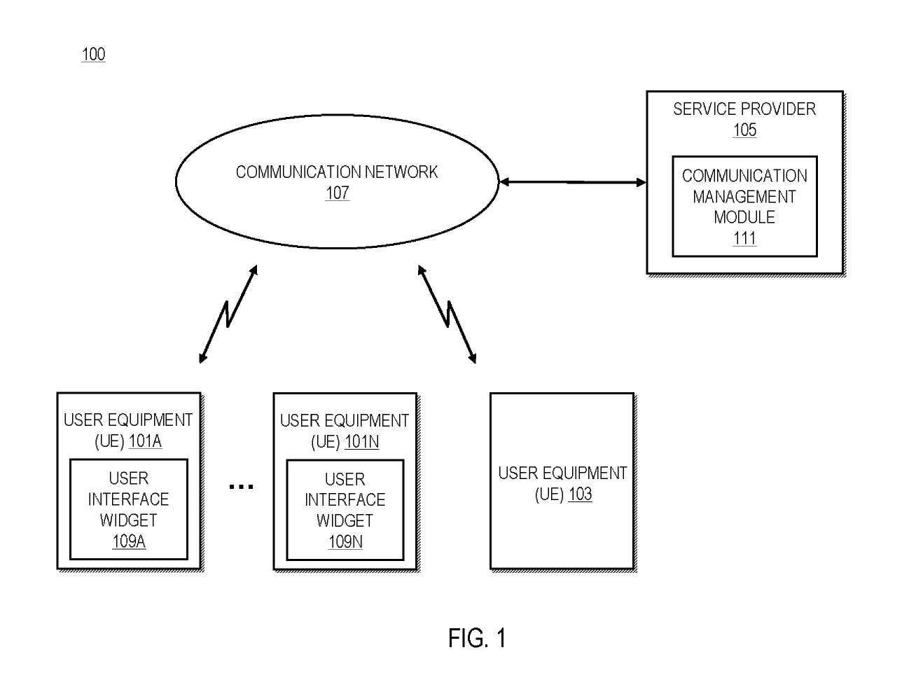

FIG. 1 is a diagram of a system 100 capable of providing context attributes and informational links for media data, according to one embodiment.

As shown in FIG. 1, the system 100 comprises user equipment (UE) 101A . . . 101N and UE 103 having connectivity to each other and to a service provider 105 via a communication network 107. By way of example, the communication network 107 of system 100 includes one or more networks such as a data network (not shown), a wireless network (not shown), a telephony network (not shown), or any combination thereof. It is contemplated that the data network may be any local area network (LAN), metropolitan area network (MAN), wide area network (WAN), a public data network (e.g., the Internet), or any other suitable packet-switched network, such as a commercially owned, proprietary packet-switched network, e.g., a proprietary cable or fiber-optic network. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), satellite, mobile ad-hoc network (MANET), and the like.

The UEs 101A . . . 101N, and 103 are any type of mobile terminal, fixed terminal, or portable terminal including a mobile handset, station, unit, device, multimedia computer, multimedia tablet, Internet node, communicator, desktop computer, laptop computer, Personal Digital Assistants (PDAs), or any combination thereof. It is also contemplated that the UEs can support any type of interface to the user (such as “wearable” circuitry, etc.).

The UEs 101A . . . 101N include a user interface widget 109A . . . 109N, while UE 103 does not include such a widget. The user interface widgets 109A . . . 109N can be used to provide context attributes and informational links for media data for the users of the respective UEs 101A . . . 101N when communicating with each other, with UE 103, and/or with service provider 105. The service provider 105 can additionally provide certain media data, context attribute data, informational data, etc. to the UEs 101A . . . 101N, and/or 103 in conjunction with the UEs in order to provide context attributes and informational links for media data thereon. Thus, even UE 103 could be provided with context attributes and informational links for media data provided by the service provider 105 using communication management module 111 in conjunction with UE 103 (e.g., utilizing a web-based application containing such a user interface widget, where the UE 103 is merely acting as a conduit for passing information between the user and the service provider). Additionally, the communication management module 111 can act as a communication session manager between UEs or between a UE and a service provider in order to control any exchange of information between the parties to the communication.

By way of example, the UEs 101A . . . 101N, UE 103, and service provider 105 communicate with each other and other components of the communication network 107 using well known, new or still developing protocols. In this context, a protocol includes a set of rules defining how the network nodes within the communication network 107 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application headers (layer 5, layer 6 and layer 7) as defined by the OSI Reference Model.

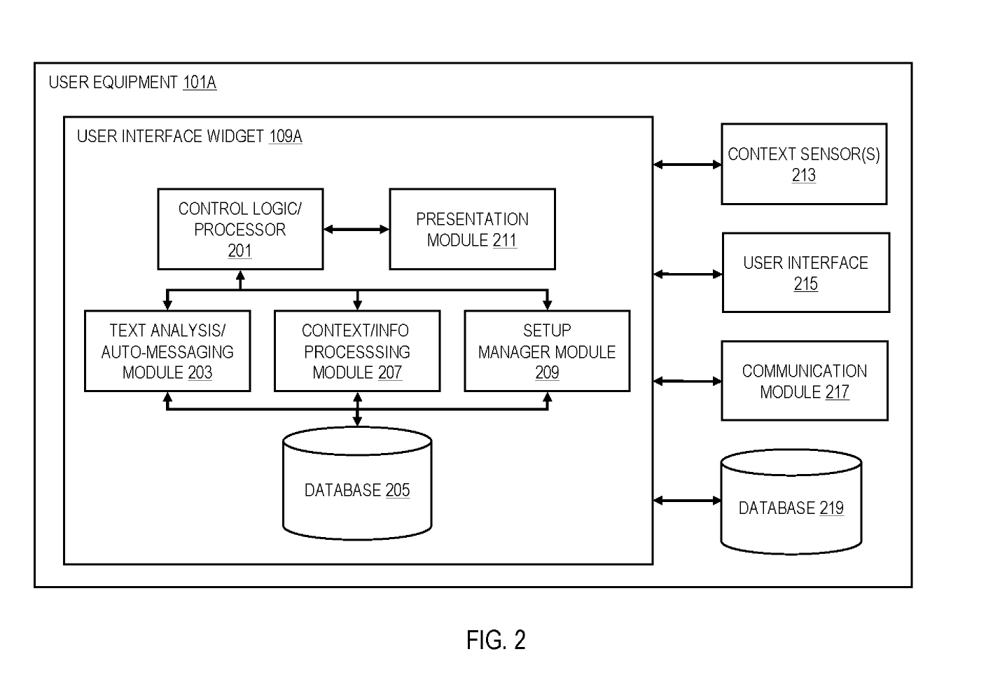

FIG. 2 is a diagram of the components of user equipment 101A including a user interface widget 109A capable of providing context attributes and informational links for media data, according to one embodiment. By way of example, the user interface widget 109A includes one or more components for providing context attributes and informational links for media data. It is contemplated that the functions of these components may be combined in one or more components or performed by other components of equivalent functionality.

In the embodiment shown in FIG. 2, the user interface widget 109A includes a control logic/processor 201, a text analysis/auto-messaging module 203, a database 205, a context/informational processing module 207, a set-up manager module 209, and a presentation module 211. Additionally, the user equipment 101A includes one or more context sensors 213, a user interface 215, a communication module 217, and a database 219. The control logic/processor 201 can be used to control the operation of the user interface widget 109A upon receiving of media data and coordinate the operations of the various components thereof. The text analysis/auto-messaging module 203 can analyze the media data by parsing the media data and/or analyzing the textual database for keywords/keyphrases, as will be discussed in greater detail below. The text analysis/auto-messaging module 203 can also compile automatic messages in response to media data received by the UI widget 109A. The database 205 can be used for storage and retrieval of data with regards to any of the components of the UI widget 109A, and can store historical data related to user usage, actions, etc. The context/informational processing module 207 can receive and process contextual attributes and informational data/links (e.g., from the context sensors 213 in the device, context sensors external to the device (e.g., in a local environment such as a “smart space”) to which the device can communicate, or from the service provider 105). The user interface widget 109A can utilize various techniques for context acquisition on mobile devices to collect the real-time values of multiple context attributes from different context data sources, such as physical sensors, software services, etc. The context attributes are a specific type of context data (e.g., location, time, activity, preference, temperature, name, friends, children, pulse, etc.) that the device collects. The set-up manager module 209 can allow the user to control the manner in which the UI widget 109A operates and presents the output display. The presentation module 211 can communicate with a display of a user interface 215 of the UE 101A to display the GUI.

The context sensors 213 can include physical sensors (e.g., global positions system (GPS) device, compass, environmental sensors (such as, a temperature sensor, pressure sensor, etc.), body sensors capable of measuring a variety of body conditions, camera, microphone, etc.), software services (e.g., weather, calendar, battery status, memory status, etc.) that are either locally provided by the device or remotely provided by a service provider and received by the device, etc. The user interface 215 can include any type of input or output device that allows the user and the user equipment to communicate with one another, such as a display screen, speaker, microphone, buttons (e.g., keyboard, dedicated physical buttons, touchscreen, etc.), etc. Additionally, the communication module 217 allows the UI widget 109A to communicate with any remote device or server, if needed in order to present objects on the GUI, or to utilize data or applications associated with the objects. Also, the database 219 can be used to store data and applications.

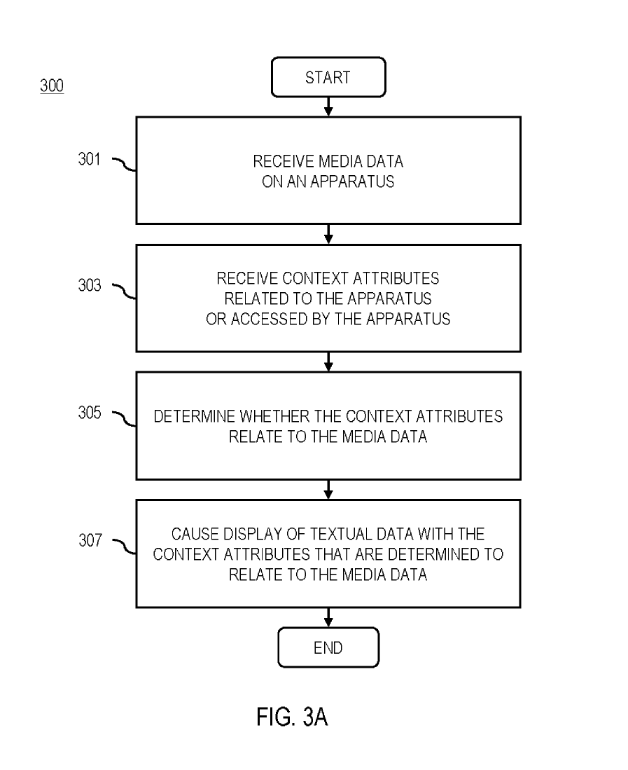

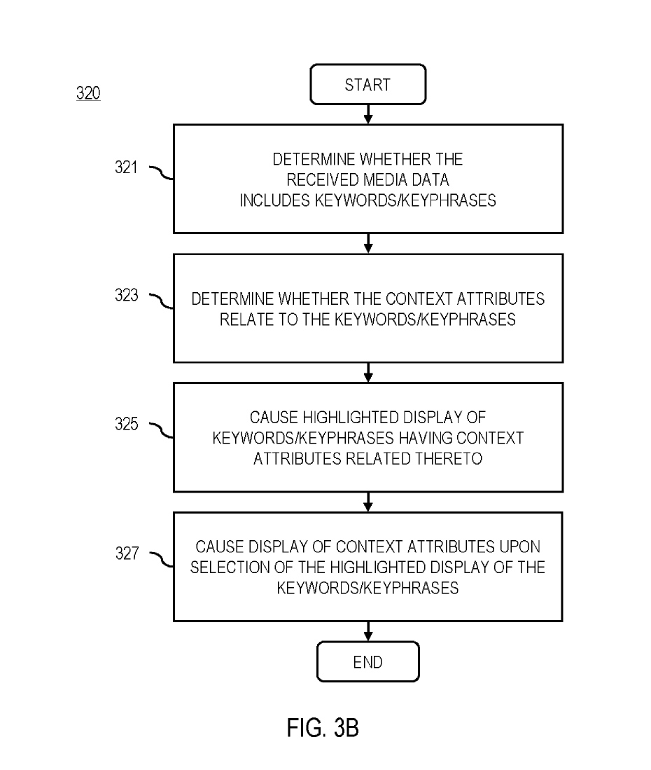

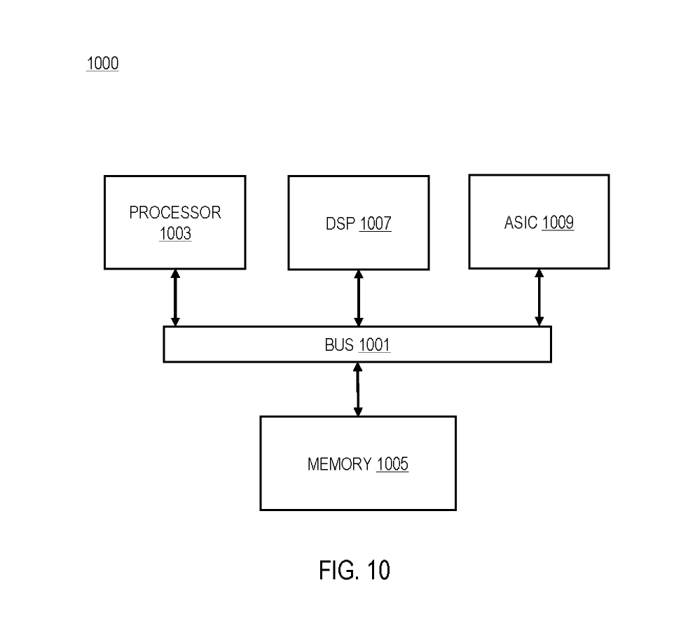

FIG. 3A is a flowchart of a process 300 for causing display of media data (e.g., textual data, multimedia data, etc.) with related context attributes, according to one embodiment, and FIG. 3B is a flowchart of a process 320 for causing display of highlighted keywords and/or keyphrases and causing display of context attributes upon selection of the highlighted display, according to one embodiment. In one embodiment, the UI widget 109A performs the processes 300 and 320, and is implemented in, for instance, a chip set including a processor and a memory as shown FIG. 10.

In step 301 of FIG. 3A, media data is received on a processor of an apparatus. For example, in the embodiment of FIG. 2, the media data can be received via the communication module 217 of the user equipment 101A by the control logic/processor 201 of the UI widget 109A, which acts as a means for receiving such media data. In step 303, context attributes related to the apparatus or accessed by the apparatus are received by the control logic/processor 201 of the UI widget 109A, which acts as a means for receiving such attributes. For example, various contextual attributes can be received from the context sensors 213 or from the service provider 105 via the communication module 217. In step 305, it is determined whether the context attributes relate to the media data. Thus, for example, the text analysis/auto-messaging module 203 can analyze the media data received and the context/informational processing module 207 can process the context attributes received, and such analysis and processing information can be assessed by the control logic/processor 201 as a means for determining whether the context attributes that are available relate to the media data that has been received. In step 307, display of the media data with the context attributes that are determined to relate to the media data is caused. For example, upon determination of related context attributes and media data, the control logic/processor 201 can act as a means for causing the user interface 215, via the presentation module 211, to cause display on a display screen of the user interface 215 of the media data and related context attributes.

As noted above, FIG. 3B is a flowchart of a process 320 for causing display of highlighted keywords and/or keyphrases and causing display of context attributes upon selection of the highlighted display, according to one embodiment. In step 321, it is determined whether the received media data includes, for example, keywords and/or keyphrases. For example, upon receipt of media data, the text analysis/auto-messaging module 203 can analyze the media data received in order to identify keywords/keyphrases that may relate to context attributes that can be provided or received by the user equipment 101A. In step 323, it is determined whether the context attributes relate to the media data. Thus, for example, the context/informational processing module 207 can process the context attributes received, and the control logic/processor 201 can determine whether the context attributes that are available relate to the keywords/keyphrases. In step 325, highlighted display of the keywords/keyphrases having context attributes that are determined to relate thereto is caused. For example, upon determination of related context attributes and keywords/keyphrases, the control logic/processor 201 can cause, as in step 327, the user interface 215, via the presentation module 211, to cause display on a display screen of the user interface 215 of highlighted keywords/keyphrases and related context attributes. For example, any keywords/keyphrases that have related context attributes can be shown in a different color than the remaining media data, or can be given some other visual highlighting (e.g., provided with flashing letters, covered with a highlighting color, surrounded by a box, etc.). Additionally, the related context attribute can be caused to be automatically displayed or can be displayed upon selection by the user of the highlighted keyword/keyphrase. The related context attribute can be displayed in a pop-up window (e.g., a transparent window (e.g., a dialog box or cloud) that is transparently displayed over other information on the screen, or in a designated area on the screen.

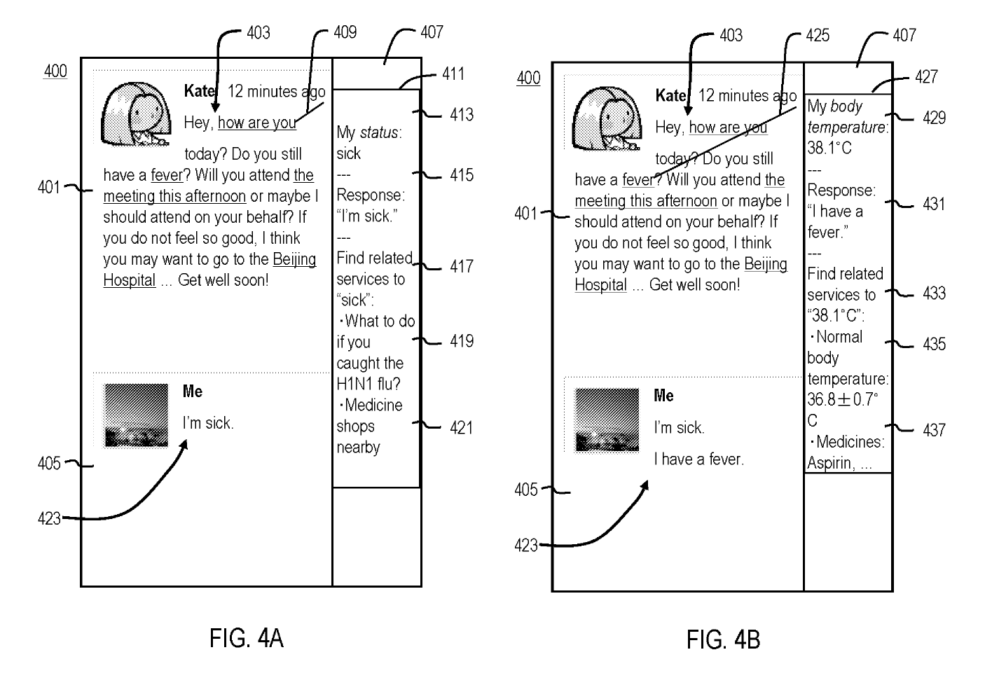

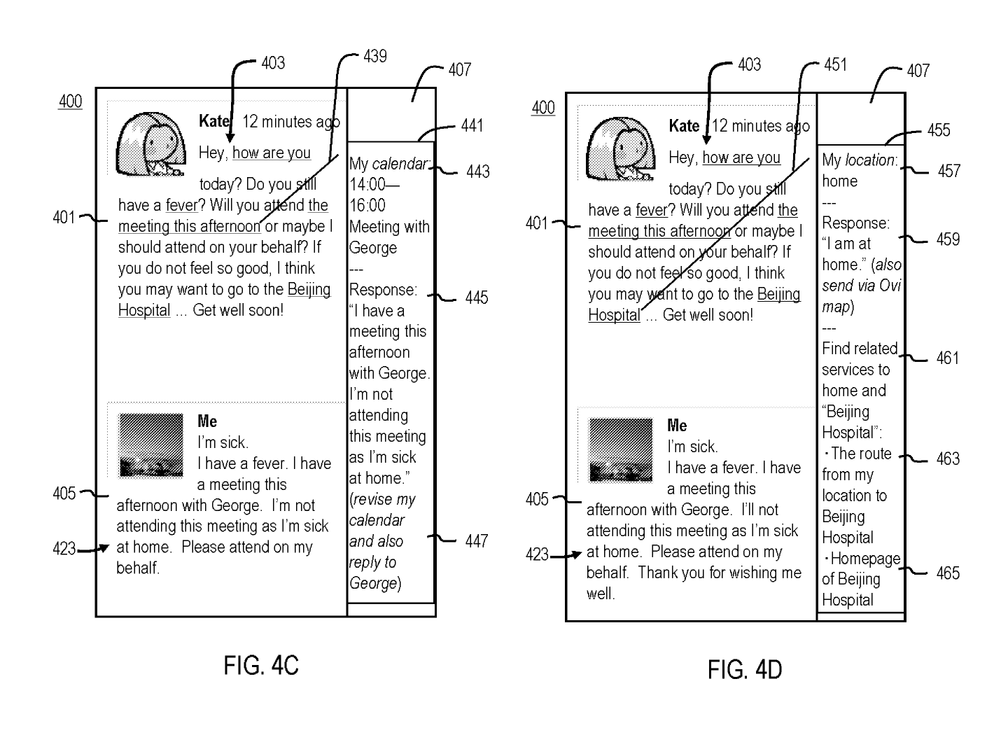

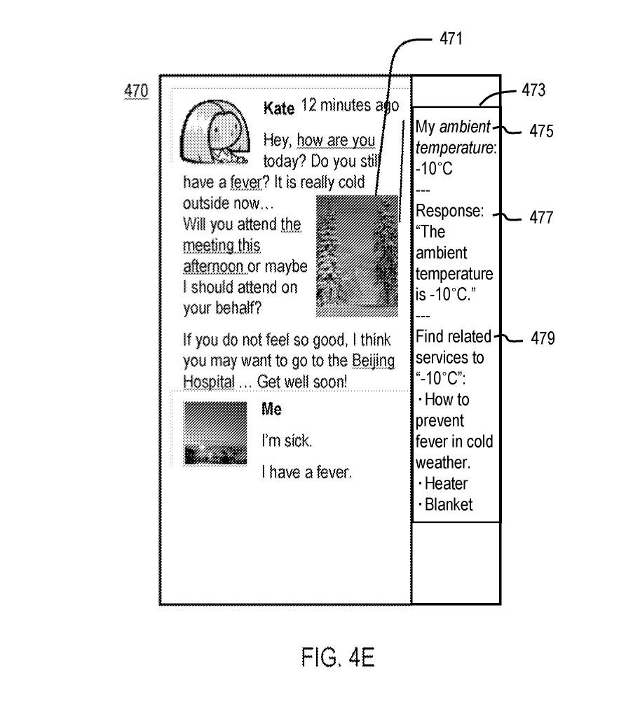

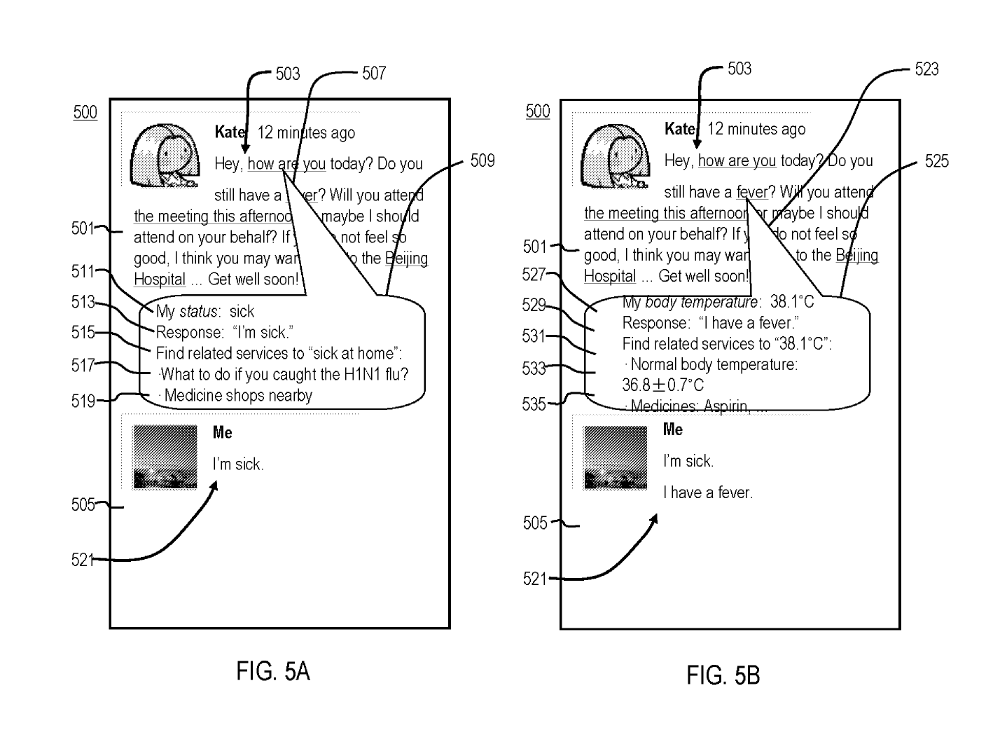

FIGS. 4A-4E and 5A-5B are diagrams of user interfaces utilized in the processes of FIGS. 3A and 3B, according to various embodiments. In these embodiments, textual data is displayed with related context attributes.

FIG. 4A depicts a user interface 400 used during a communication (e.g., a short message service (SMS) communication, instant message (IM) communication, electronic mail communication, etc.) between a remote user (i.e., referred as “Kate”) and the user of the device upon which the user interface 400 is displayed (i.e., referred to as “Me”). In FIG. 4A, a first area 401 is provided that includes a message 403 received from “Kate” and a second area 405 that includes a message from “Me”. While only two messages are displayed in FIG. 4A, it should be noted that additional messages can be displayed chronologically descending downwardly, such that the user interface 400 can be used to scroll upwards and downwards to display the desired messages. In FIG. 4A, a window 407 is provided on a right side of the display screen, which can be used to display the context attributes and informational links. The window 407 could be provided at any location on the display screen, and can either be provided in a distinct panel (as shown in FIG. 4A) or can be displayed transparently over other data on the display screen.

As shown in FIG. 4A, the message 403 has been analyzed by the UI widget, and available context attributes and the informational links have been processed, which leads to several keywords/keyphrases that have related context attributes have been highlighted by underlining. In this example, the keyphrase “how are you” has been highlighted, the keyword “fever” has been highlighted, the keyphrase “the meeting this afternoon” has been highlighted, and the keyphrase “Beijing Hospital” has been highlighted. In FIG. 4A, the keyphrase “how are you” has been selected either by the user or automatically by default, as indicated by a leaderline 409, and a context attribute/informational link box 411 associated with the keyphrase “how are you” has been displayed in the window 407. The box 411 includes a context attribute named “status” that indicates the user's physical status 413 as being “sick” which can be entered by the user as a current status, or can be determined by one or more context sensors (e.g., GPS data regarding the location of the device, body temperature sensor reading indicating that the user has an elevated temperature, etc.). The box 411 also includes an automated response 415 to the keyphrase, which states “I′m sick.” Thus, if the user decides that this response is appropriate then the user can select this automated response and this text will appear in the area 405, as shown by response 423 in FIG. 4A. The box 411 also includes additional informational links 417, such as the related services to “sick” listed as link 419 and link 421. The user can then select such link(s) in order to receive further information (e.g., via the internet) either through importing of such information into the user interface 400 or by being transferred to a website link thereto in a web browser in order to find further information on that subject.

In FIG. 4B, the keyword “fever” has been selected either by the user or automatically by default, as indicated by a leaderline 425, and a context attribute/informational link box 427 associated with the keyword “fever” has been displayed in the window 407. The box 427 includes a context attribute named “body temperature” that indicates the user's body temperature status 429 as being “38.1° C.,” which can be entered by the user as a current status, or can be determined by one or more context sensors (e.g., body temperature sensor reading indicating that the user's temperature). The box 427 also includes an automated response 431 to the keyword, which states “I have a fever.” Thus, if the user decides that this response is appropriate then the user can select this automated response and this text will appear in the area 405, as shown by response 423 in FIG. 4B. The box 427 also includes additional informational links 433, such as the related services to “38.1° C.” listed as link 435 and link 437. The user can then select such link(s) in order to receive further information on that subject.

In FIG. 4C, the keyphrase “the meeting this afternoon” has been selected either by the user or automatically by default, as indicated by a leaderline 439, and a context attribute/informational link box 441 associated with the keyphrase “the meeting this afternoon” has been displayed in the window 407. The box 441 includes a context attribute named “calendar” that indicates the user's calendar status 443 as including a meeting with George from 14:00 to 16:00, which can be entered by the user as a current status, or can be determined by one or more context sensors (e.g., by accessing the user's calendar entries for the afternoon). The box 441 also includes an automated response 445 to the keyphrase, which states “I have a meeting this afternoon with George. I′m not attending this meeting as I′m sick at home.” Thus, if the user decides that this response is appropriate then the user can select this automated response and this text will appear in the area 405, as shown by response 423 in FIG. 4C. Note that the user has also entered additional text that states “Please attend on my behalf” Additionally, if desired, the user could select the automated response and then make modifications thereto in order to fit the user's needs. The box 441 also includes an additional informational link 447, that reminds the user to revise the user's calendar and send a message to George regarding any changes to the meeting, and which can include links to the calendar application and the messaging applications or contacts list. The user can then select such link(s) in order to perform any necessary tasks.

In FIG. 4D, the keyphrase “Beijing Hospital” has been selected either by the user or automatically by default, as indicated by a leaderline 451, and a context attribute/informational link box 455 associated with the keyphrase “Beijing Hospital” has been displayed in the window 407. The box 455 includes a context attribute named “location” that indicates the user's location status 457 as being at “home” which can be entered by the user as a current status, or can be determined by one or more context sensors (e.g., GPS device). The box 455 also includes an automated response 459 to the keyphrase, which states “I am at home” and can also include a link that allows the user to send the user's location via Ovi® map or other mapping application. Thus, if the user decides that this response is appropriate then the user can select this automated response and this text will appear in the area 405. While the automated response has not been selected in this instance, the user has included additional text (i.e., “Thank you for wishing me well”) in the response 423 in FIG. 4D. The box 455 also includes additional informational links 461, such as the related services to the address of the user's home and “Beijing Hospital” listed as link 463 and link 465. The user can then select such link(s) in order to receive further information on that subject.

FIG. 4E depicts a user interface 470 used during a communication (e.g., a short message service (SMS) communication, instant message (IM) communication, electronic mail communication, etc.) between a remote user (i.e., referred as “Kate”) and the user of the device upon which the user interface 470 is displayed (i.e., referred to as “Me”). In the first area, the message received from “Kate” includes a picture 471 that relates to the statement “It is really cold outside” in the message. In this embodiment, after content analysis, the metadata of an image in a multimedia messaging service (MMS) is matched to the context attribute “ambient temperature” on the apparatus. When the image is highlighted, in the manner described above with regards to a keyword/keyphrase, the real-time value of the attribute is displayed.

Thus, in FIG. 4E, the picture 471 has been selected either by the user or automatically by default, as indicated by a leaderline, and a context attribute/informational link box 473 associated with the picture 471 and associated context attribute regarding the user's current ambient temperature has been displayed in the side window. The box 473 includes a context attribute named “ambient temperature” that indicates the user's ambient temperature 475 as being “−10° C.” which can be entered by the user as a current status, or can be determined by one or more context sensors (e.g., temperature sensor at the user's location, web data indicating the current ambient temperature at the user's general location, etc.). The box 473 also includes an automated response 477, which states “The ambient temperature is −10° C.” Thus, if the user decides that this response is appropriate then the user can select this automated response and this text will appear in the second area. The box 473 also includes additional informational links 479, such as the related services to “−10° C.”. The user can then select such link(s) in order to receive further information (e.g., via the internet) either through importing of such information into the user interface 470 or by being transferred to a website link thereto in a web browser in order to find further information on that subject.

FIGS. 5A-5B are diagrams of user interfaces utilized in the processes of FIGS. 3A and 3B, according to various embodiments. FIGS. 5A and 5B are similar to FIGS. 4A and 4B; however, in FIGS. 5A and 5B, instead of a sidebar, the GUI utilizes a pop-up text box to display the context attributes and informational links. The pop-up text box can be transparent or opaque.

As shown in FIG. 5A, the message 503 has been analyzed by the UI widget, and available context attributes have been processed, and several keywords/keyphrases that have related context attributes have been highlighted by underlining. In this example, the keyphrase “how are you” has been highlighted, the keyword “fever” has been highlighted, the keyphrase “the meeting this afternoon” has been highlighted, and the keyphrase “Beijing Hospital” has been highlighted. In FIG. 5A, the keyphrase “how are you” has been selected either by the user or automatically by default, as indicated by a leaderline 507, and a context attribute/informational link pop-up box 509 associated with the keyphrase “how are you” has been displayed in a first area 501 of the user interface 500. The box 509 includes a context attribute named “status” that indicates the user's physical status 511 as being “sick”, which can be entered by the user as a current status, or can be determined by one or more context sensors (e.g., GPS data regarding the location of the device, body temperature sensor reading indicating that the user has an elevated temperature, etc.). The box 509 also includes an automated response 513 to the keyphrase, which states “I′m sick.” Thus, if the user decides that this response is appropriate than the user can select this automated response and this text will appear in the second area 505, as shown by response 521 in FIG. 5A. The box 509 also includes additional informational links 515, such as the related services to “sick” listed as link 517 and link 519. The user can then select such link(s) in order to receive further information (e.g., via the internet) either through importing of such information into the user interface 500 or by being transferred to a website link thereto in a web browser in order to find further information on that subject.

In FIG. 5B, the keyword “fever” has been selected either by the user or automatically by default, as indicated by a leaderline 523, and a context attribute/informational link pop-up box 525 associated with the keyword “fever” has been displayed in the user interface 500. The box 525 includes a context attribute named “body temperature” that indicates the user's body temperature status 527 as being “38.1° C.,” which can be entered by the user as a current status, or can be determined by one or more context sensors (e.g., body temperature sensor reading indicating that the user's temperature). The box 525 also includes an automated response 529 to the keyword, which states “I have a fever.” Thus, if the user decides that this response is appropriate then the user can select this automated response and this text will appear in the area 505, as shown by response 521 in FIG. 5B. The box 525 also includes additional informational links 531, such as the related services to “38.1° C.” listed as link 533 and link 535. The user can then select such link(s) in order to receive further information on that subject.

While FIGS. 3A through 5B depict several embodiments of the user interface and associated methods of providing such a user interface, numerous variations thereof are contemplated and can be provided utilizing the disclosure set forth herein. The user interface widget can utilize various techniques for natural language processing that can be used in conjunction with various text-based communication services on current mobile devices (e.g., SMS, web browser, e-mail, instant messaging and chat rooms). The user interface widget can utilize various techniques for context acquisition on mobile devices to collect the real-time values of multiple context attributes from different context data sources. Examples of these sources include the physical sensors (e.g., GPS, body sensors, camera, microphone and environmental sensors) and the software services (e.g., weather service, calendar, battery status and memory status). Example context attributes that can be received by the mobile device are location, time, activity, preference, temperature, name, friends, children and pulse.

The UI widget can match textual metadata of any media data to context attributes on the apparatus. The textual metadata can be stored separately from the content data, for example, on permanent storage of the apparatus, and the stored textual metadata can be linked to the content data. The keywords/keyphrases in the metadata can then be highlighted when it is viewed by the user of the apparatus, and/or the original content data can directly be highlighted when it is viewed by the user.

The UI widget can provide automatic highlighting of context-correlated keywords/keyphrases, by analyzing every piece of incoming or outgoing text in real time when the text is received or when the text is being composed to be sent. The UI widget can find every keyword/keyphrase in the text that, for example, has matching semantics to a context attribute received by the mobile device. The UI widget can cause the display of keywords/keyphrases as “highlighted” on the device screen each time when the text is read by the user. For example, such highlighting can be based on underlining or using a different font color; it can be activated or deactivated via different ways of user input such as keypad presses, touch screen selections and voice commands.

The UI widget can provide dynamic display of real-time context. For example, whenever a keyword/keyphrase is activated (shown), the real-time value of the corresponding context attribute is shown. The context display is “real-time”, for example, a different and updated context attribute value can be presented each time when the user accesses the text and reads the context display. The context display can be provided in a pop-up text box or an attached sidebar. The displayed contextual information can be for the reference of the user only, and may or may not be useful for the user at the moment, thus the user can decide to whether to view a real-time value or simply ignore it or view it at a later time.

The contextual highlighting can be used for various services, such as context-based service search, automatic message composition, dynamic advertisement dissemination, and so on. The context-based UI and linked services are aimed to provide a better user experience. The UI can automatically associate real-time contextual data of mobile device users to their daily usage of traditional communication services. The UI widget can utilize text analytics and text mining. The UI widget can provide name and instance based semantic matching, for example, by matching a keyword in the text with the names of the context attributes, textual descriptions of the attributes (if any), sample values of the attributes, weighted combination of the above, and so on.

The context/informational link display (e.g., in a pop-up text box or sidebar) can be attached with a command option that allows the mobile device user to use a template to automatically compose a message embedded with the real-time context attribute value and/or the keyword/keyphrase. The template can be either pre-defined by the user or be constructed at run time via natural language processing. Context data can be inserted into proper positions in the template by pre-defined placeholders. The templates are stored at a local template database, such as database 205 in FIG. 2. Icons and/or images can be embedded into the template. Thus, the user can simply select to reply this automatically generated contextual message constructed from a template to the sender of the original message, or to disseminate it to a group of other people. The group can be either pre-defined (e.g., in the contact list) or run-time specified (e.g., via a search condition).

In other embodiments, the UI widget can provide real-time contextual highlighting for keywords/keyphrases in the textual contents of web browser pages that the user is currently surfing. The UI widget can also display advertisements that are related to the highlighted keywords/keyphrases in a sidebar of the browser. The UI widget can filter these advertisements using the real-time values of context attributes corresponding to the keywords/keyphrases. The UI widget can also be applied for advertisement attachment for various communication services, such as SMS, instant messaging and chat room. For example, in a situation where the user's context environmental_humidity is low, the UI widget highlights the keyword “humidity” in the current browser web page and displays a few advertisements of humidifiers. In another example, in a situation where the user's context number_of_children is not zero, then the UI widget highlights the keyword “children” in the current instant message and provides a dynamic display including corresponding advertisements and links for children's stuff (e.g., toys, clothes, etc.) in the IM software sidebars.

In yet another embodiment, the UI widget can be utilized in a music player to match keywords/keyphrases in lyrics of a song to context attributes. The lyrics can be provided as metadata with the music content, accessed using a service via the web, determined using speech recognition, etc. The keywords/keyphrases can then be highlighted, and real-time context attribute values can be displayed, and corresponding services/advertisements can be searched or displayed.

In another embodiment, speech recognition can be utilized to get a textual summary (i.e. metadata) of a video/voice phone call. Texts in such metadata can then be analyzed and highlighted, context attribute values can be displayed, and corresponding services/advertisements can be searched or displayed.

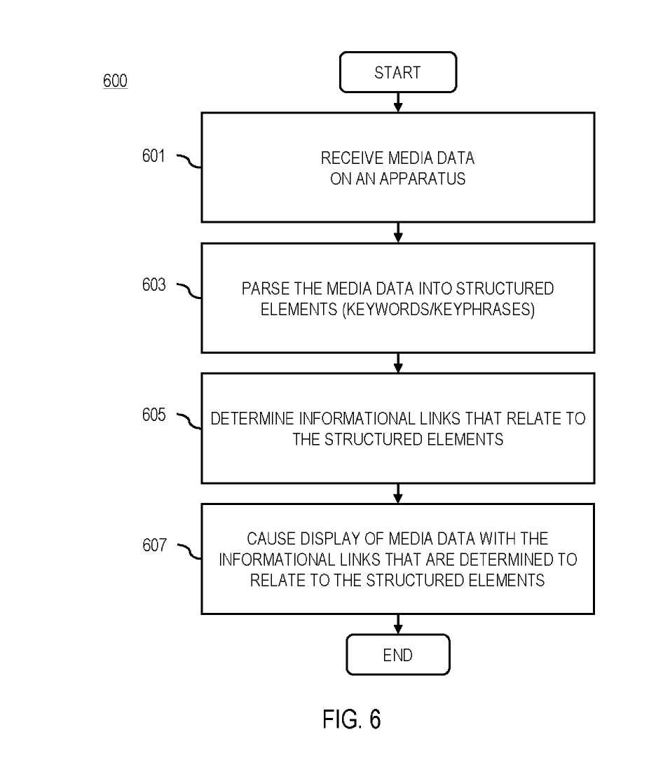

FIG. 6 is a flowchart of a process 600 for causing display of media data with informational links related to structured elements of the media data, according to one embodiment. In one embodiment, the UI widget 109A performs the process 600 and is implemented in, for instance, a chip set including a processor and a memory as shown FIG. 10.

In step 601 of FIG. 6, media data is received on a processor of an apparatus. For example, in the embodiment of FIG. 2, the media data can be received via the communication module 217 of the user equipment 101A by the control logic/processor 201 of the UI widget 109A, which acts as a means for receiving such media data. In step 603, the media data is parsed into structured elements (i.e., keywords/keyphrases), for example, by the text analysis/auto-messaging module 203, which acts as a means for parsing. In step 605, informational links that relate to the structured elements are determined. Thus, for example, the context/informational processing module 207 can process the informational links that are available, and such information can be assessed by the control logic/processor 201 as a means for determining whether the informational links that are available relate to the structured elements of the media data that has been received. In step 607, display of the media data with the informational links that are determined to relate to the structured elements of the media data is caused. For example, upon determination of related informational links and media data, the control logic/processor 201 can act as a means for causing the user interface 215, via the presentation module 211, to cause display on a display screen of the user interface 215 of the structured elements/media data and related informational links.

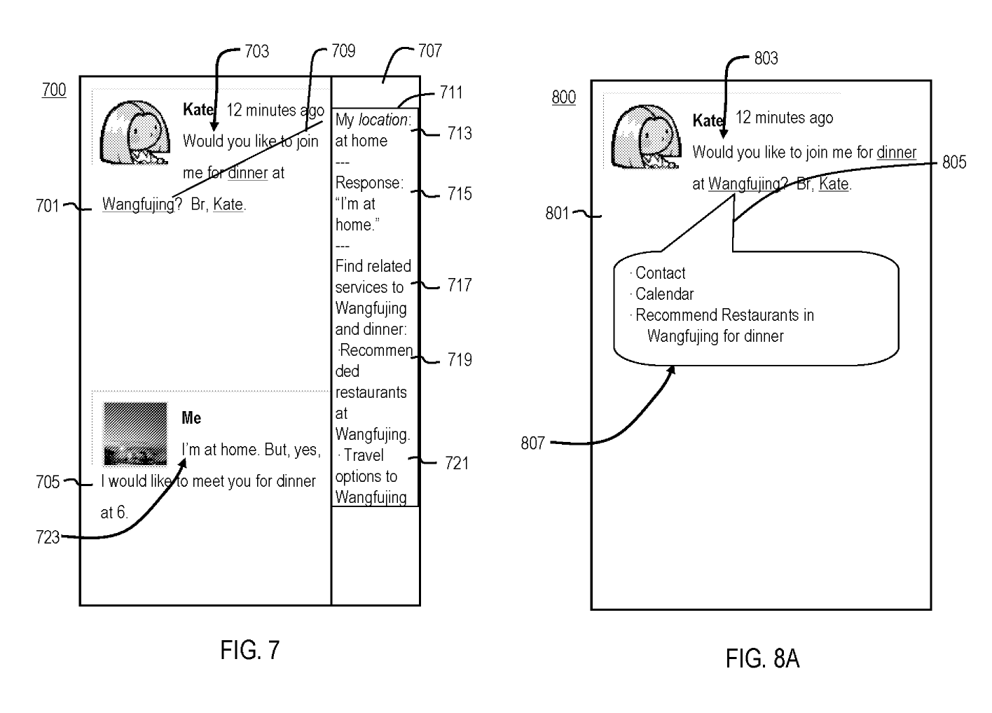

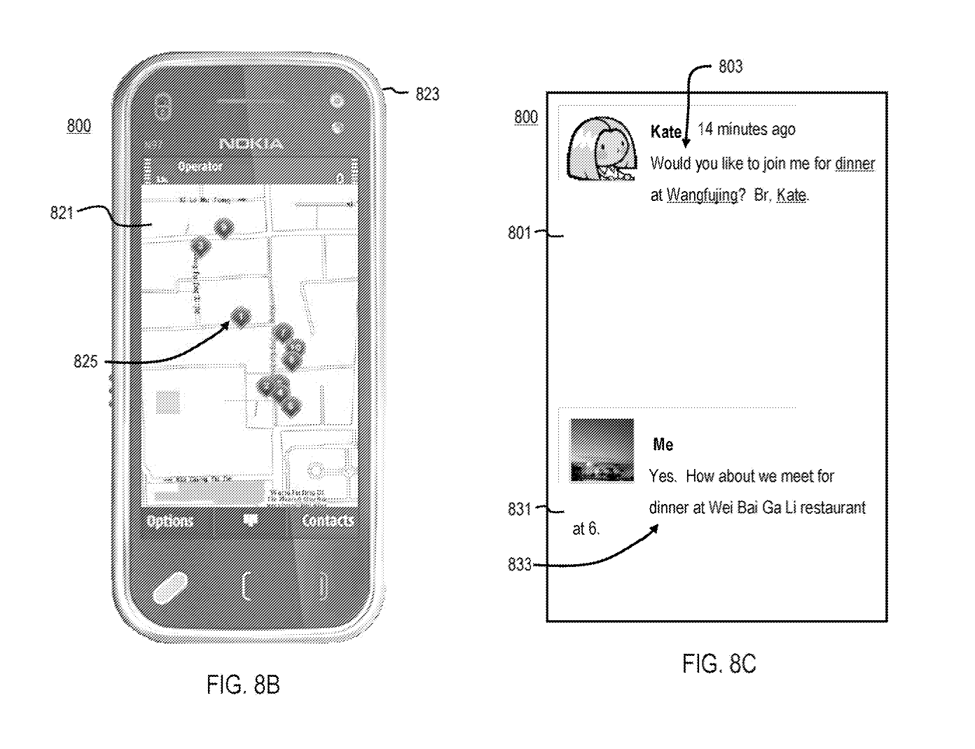

FIG. 7 is a diagram of a user interface utilized in the process of FIG. 6, according to various embodiments. FIGS. 8A-8C are diagrams of user interfaces utilized in the process of FIG. 6, where FIG. 8B is shown on a mobile device, according to various embodiments. In these embodiments, textual data is displayed with related context attributes.

FIG. 7 depicts a user interface 700 used during a communication (e.g., a short message service (SMS) communication, instant message (IM) communication, electronic mail communication, etc.) between a remote user (i.e., referred as “Kate”) and the user of the device upon which the user interface 700 is displayed (i.e., referred to as “Me”). In FIG. 7, a first area 701 is provided that includes a message 703 received from “Kate” and a second area 705 that includes a message from “Me”. While only two messages are displayed in FIG. 7, it should be noted that additional messages can be displayed chronologically descending downwardly, such that the user interface 700 can be used to scroll upwards and downwards to display the desired messages. In FIG. 7, a window 707 is provided on a right side of the display screen, which can be used to display the context attributes and informational links. The window 707 could be provided at any location on the display screen, and can either be provided in a distinct panel (as shown in FIG. 7) or can be displayed transparently over other data on the display screen.

As shown in FIG. 7, the message 703 has been analyzed by the UI widget such that structured elements (i.e., keyword/keyphrases) are parsed out of the media data, which in this instance is textual data, and available context attributes and informational links have been processed, and several keywords/keyphrases that have related context attributes/informational links have been highlighted by underlining. In this example, the keyword “dinner” has been highlighted, the keyword “Wangfujing” has been highlighted, and the keyword “Kate” has been highlighted. In this embodiment, all of these highlighted keywords/keyphrases are analyzed together in combination in order to provide related context attributes and informational links for this combination of keywords/keyphrases. In FIG. 7, the combined keywords/keyphrases have been selected either by the user or automatically by default, as indicated by a leaderline 709, and a context attribute/informational link box 711 associated with the combined keywords/keyphrases have been displayed in the window 707. The box 711 includes a context attribute that indicates the user's location status 713 as being “at home,” which can be entered by the user as a current status, or can be determined by one or more context sensors (e.g., GPS data regarding the location of the device, body temperature sensor reading indicating that the user has an elevated temperature, etc.). The box 711 also includes an automated response 715, which states “I′m at home.” Thus, if the user decides that this response is appropriate then the user can select this automated response and this text will appear in the area 705, as shown by response 723 in FIG. 7. The box 711 also includes additional informational links 717, such as the related services to restaurants at “Wangfujing” listed as link 719 and link 721, which can provide suggestions for dinner restaurants near Wangfujing. The user can then select such link(s) in order to receive further information (e.g., via the internet) either through importing of such information into the user interface 700 or by being transferred to a website link thereto in a web browser in order to find further information on that subject.

FIGS. 8A-8C are diagrams of user interfaces utilized in the process of FIG. 6, where FIG. 8B is shown on a mobile device, according to various embodiments. The user interfaces shown in FIG. 8A utilizes a pop-up text box to display the context attributes and informational links. The pop-up text box can be transparent or opaque.

FIGS. 8A-8C depict a user interface 800 used during a communication (e.g., a short message service (SMS) communication, instant message (IM) communication, electronic mail communication, etc.) between a remote user (i.e., referred as “Kate”) and the user of the device upon which the user interface 800 is displayed (i.e., referred to as “Me”). In FIG. 8A, a first area 801 is provided that includes a message 803 received from “Kate.” While only one message is displayed in FIG. 8A, it should be noted that additional messages can be displayed chronologically descending downwardly, such that the user interface 800 can be used to scroll upwards and downwards to display the desired messages.

As shown in FIG. 8A, the message 803 has been analyzed by the UI widget such that structured elements (i.e., keyword/keyphrases) are parsed out of the textual data, and available context attributes and informational links have been processed, and several keywords/keyphrases that have related context attributes/informational links have been highlighted by underlining, in the same manner as shown in FIG. 7. In FIG. 8A, the combined keywords/keyphrases have been selected either by the user or automatically by default, as indicated by a leaderline 805, and a context attribute/informational link box 807 associated with the combined keywords/keyphrases have been displayed. The box 807 includes a contact link (e.g., if the user wants to search for contact information for “Kate”), a calendar link (e.g., if the user wants to search calendar entries for the evening, or add a calendar entry for dinner), and a link to recommended restaurants in the Wangfujing area (e.g., if the user wants to search for restaurants, or restaurant contact information, etc.). If the user selects, for example, the link to recommended restaurants, then the user interface can open a mapping application that shows such recommended restaurants, for example, as shown in FIG. 8B.

In FIG. 8B, the user interface 800 displays a mapping application 821 on a display screen of the mobile device 823, which includes a plurality of markers 825 that indicate recommended restaurants in the Wangfujing area. The user can select such markers in order to obtain further information for the restaurant (e.g., name, address, contact information, web link, customer ratings, reviews, etc.). If the user desires, the user can select one of the restaurants, which can then be forwarded to the other person (i.e., “Kate” in this instance) in a format as shown in the user interface in FIG. 8B, and/or can be used in an automated message as shown in the second area 831 as response 833 in FIG. 8C. Thus, by selecting Wei Bai Ga Li restaurant, an automated message can be generated that suggests meeting for dinner at Wei Bai Ga Li restaurant. The user can then further modify the message to include a time, or such time can be entered based on calendar entries made by the user for dinner at the selected restaurant.

Thus, the UI widget can provide intelligent point-of-interest (POI) recommendations for a map service. The UI widget can analyze location-based semantic information from a text communication that is sent or received by a user. Textual communications, especially in mobile devices, provide a key communication method for users. Such communications frequently express a users' intention, and therefore, intelligent messaging services that can automatically mine and apply useful concepts will bring significant amount of value to the customers.

Though a textual communication may contain a rich set of information, to properly use the information, a user currently has to take further action manually. On the other hand, automatic POI recommendations, such as can be provided by the UI widget, based on the user's intentions can enable truly intelligent and personalized services. The UI widget establishes a way to automatically recommend the POIs to individuals from their interactions in textual communications. Recommended POIs represent the true information needs, and are customized towards the user's daily life. Hence, these POIs really matter to the user's life and have been specifically selected because they are more likely to be of interest to those individual users. The UI widget provides dynamic, real-time recommendations in the POI domain that are based on a user's intentions that are directly mined from the textual communications, and not solely from user history.

In various embodiments of the UI widget, named entity recognition (NER) applies natural language processing (NLP) techniques to parse a text message or other media data into a set of structured elements (also referred to herein as keywords/keyphrases), such as a person's name, location name, organization name, events, identifiable phone numbers, card numbers, etc. A variety of the algorithms have been developed in different commercial domains to perform such language processing techniques. In the case of SMS processing, events that a message describes can be retrieved (or parsed out of textual data), which can include time information, location information, person information, and related actions information. For example, Hidden Markov Model (HMM) can be used to tag a message with labels having the greatest probabilities. By parsing textual data of, for example, an SMS message, into structured information with a NER engine, it can enable automatic intelligent recommendation based on a user's intentions from the SMS message.

A given SMS message can, therefore, be parsed into structured elements for further analysis and comparison with available contextual data and/or informational links. For example, for an SMS message that states “Let's have dinner at Wangfujing Street, br, John,” the SMS message can be parsed to include the following keywords/keyphrases: “dinner”, “Wangfujing”, and “John”. In this instance, the keyword “dinner” is tagged as an event category, the keyword “Wangfujing” is tagged as a location, and the keyword “John” is tagged as a name. Given the extracted knowledge on the location and event pair, recommendations become possible by efficiently converting the location and category pair to a set of relevant POIs. Thus, a local search POI query can be formed as follows:
Location=“Wangfujing”; and
Category=“Restaurant”.
   Thus, the local search engine can then recommend a restaurant close to the Wangfujing area.

There are several approaches to map the keyword to the concept. For example, taking “restaurant” as one concept entity, the relevant keywords can be found from a large training corpus, such as Wikipedia®. It can be provided as either a bag of words or a similarity measure to the concept entity (e.g., restaurant=restaurant, breakfast, lunch, dinner, supper, eating, cafe, food, etc. . . . ). With this model, the event defined in the text message can be mapped to its normalized category (e.g., mapping from event instance (e.g., dinner) to concept entity (e.g., restaurant)). Clearly, the query pattern (i.e., location+category) can then be set to the local search engine to fetch the recommended POIs. The query can be generalized as (context+category) pattern, where context can be described as temporal features or combination of the context as higher level of context.

Thus, as seen in FIG. 8B, the user interface 800 can display a mapping application 821 on a display screen of the mobile device 823, which includes a plurality of markers 825 that indicate recommended restaurants in the Wangfujing area by using such an analysis. Additionally, since a user's behavior can be modeled in the mobile device, the recommended POIs can also be filtered out to match the user's information needs.

The following description presents a technical exemplary implementation of POI recommendations based on messaging channels like SMS; however, other embodiments are not limited to these implementation alternatives. This implementation is only provided as the reference embodiment.

Named entity recognition engine has been developed both with conditional random field (CRF) and Hidden Markov model (HMM). The model can be trained with an annotated text corpus. In one embodiment, the model has been trained using China Daily collected for a few years. Annotation includes the person name, location name, organization name, primary part of speech (POS). The time, number and digit are extracted with regular expression pattern. The NER parse is then built with the supports from a trained model. The performance of NER that has been integrated in the S60 device has been optimized with real time processing capability. The NER recognition accuracy is summarized in Table 1.

TABLE 1
Accuracy of NER on unknown test sets

Accuracy

| Test set | Set 1: 2000 sentences | Set 2: 13167 sentences |
|---|---|---|
| Total | 0.801223 | 0.822878 |

The local search engine is specialized in POI searches and place recommendations. It is a flexible, scalable, and efficient local search system for the purposes of context-based search and behavioral ranking. The system can be used to search for POIs and addresses near a specified location with free-text keywords to retrieve suggestions for query completion and interpretation. For example, one can search for “Wangfujing Pizza”. Web-based UI for search and for query completion suggestions are supported. By utilizing the NER parsed structured data as mentioned above, it is possible to automatically and intelligently form the query for the local search engine to obtain the recommended POIs. The obtained POIs can be further used to match a user's behavior models and formalize the final recommendation list being shown to the user.

The UI widget clearly improves the user experience by enhancing, for example, an otherwise plain and dull SMS interface. It offers the user a very intuitive and easy way to access the service. Additionally, the user interface widget can also link together different applications (e.g., an SMS application and a mapping application), which can increase the user base of such application services. The user interface widget provides a solution-oriented offering, to enhance device and service use, in a unified business circle of a variety of different application services.

The processes described herein for providing context attributes and informational links for media data may be advantageously implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

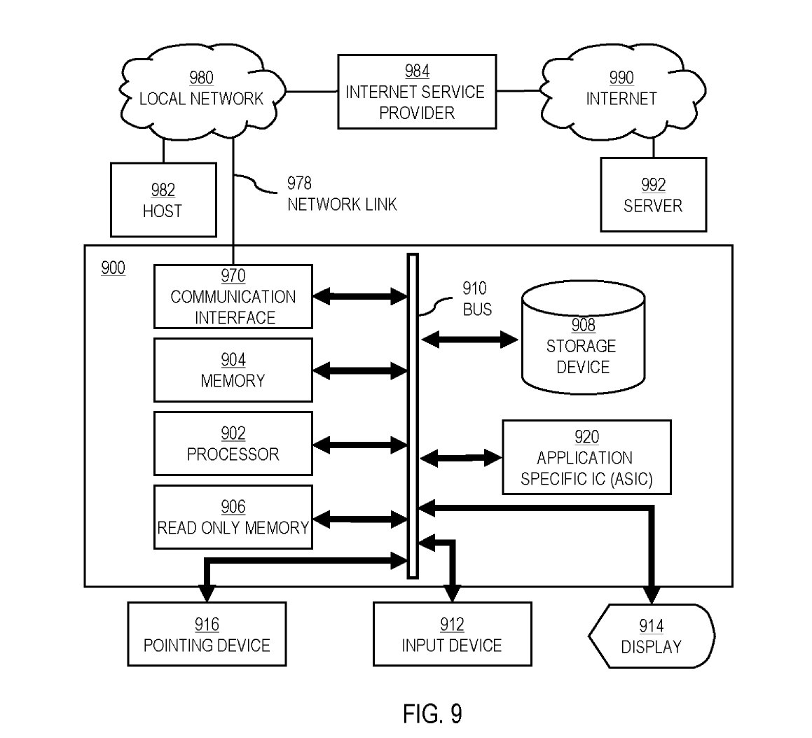

FIG. 9 illustrates a computer system 900 upon which an embodiment of the invention may be implemented. Although computer system 900 is depicted with respect to a particular device or equipment, it is contemplated that other devices or equipment (e.g., network elements, servers, etc.) within FIG. 9 can deploy the illustrated hardware and components of system 900. Computer system 900 is programmed (e.g., via computer program code or instructions) to provide context attributes and informational links for media data as described herein and includes a communication mechanism such as a bus 910 for passing information between other internal and external components of the computer system 900. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 900, or a portion thereof, constitutes a means for performing one or more steps of providing context attributes and informational links for media data.

A bus 910 includes one or more parallel conductors of information so that information is transferred quickly among devices coupled to the bus 910. One or more processors 902 for processing information are coupled with the bus 910.

A processor 902 performs a set of operations on information as specified by computer program code related to provide context attributes and informational links for media data. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 910 and placing information on the bus 910. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 902, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 900 also includes a memory 904 coupled to bus 910. The memory 904, such as a random access memory (RAM) or other dynamic storage device, stores information including processor instructions for providing context attributes and informational links for media data. Dynamic memory allows information stored therein to be changed by the computer system 900. RAM allows a unit of information stored at a location called a memory address to be stored and retrieved independently of information at neighboring addresses. The memory 904 is also used by the processor 902 to store temporary values during execution of processor instructions. The computer system 900 also includes a read only memory (ROM) 906 or other static storage device coupled to the bus 910 for storing static information, including instructions, that is not changed by the computer system 900. Some memory is composed of volatile storage that loses the information stored thereon when power is lost. Also coupled to bus 910 is a non-volatile (persistent) storage device 908, such as a magnetic disk, optical disk or flash card, for storing information, including instructions, that persists even when the computer system 900 is turned off or otherwise loses power.

Information, including instructions for providing context attributes and informational links for media data, is provided to the bus 910 for use by the processor from an external input device 912, such as a keyboard containing alphanumeric keys operated by a human user, or a sensor. A sensor detects conditions in its vicinity and transforms those detections into physical expression compatible with the measurable phenomenon used to represent information in computer system 900. Other external devices coupled to bus 910, used primarily for interacting with humans, include a display device 914, such as a cathode ray tube (CRT) or a liquid crystal display (LCD), or plasma screen or printer for presenting text or images, and a pointing device 916, such as a mouse or a trackball or cursor direction keys, or motion sensor, for controlling a position of a small cursor image presented on the display 914 and issuing commands associated with graphical elements presented on the display 914. In some embodiments, for example, in embodiments in which the computer system 900 performs all functions automatically without human input, one or more of external input device 912, display device 914 and pointing device 916 is omitted.

In the illustrated embodiment, special purpose hardware, such as an application specific integrated circuit (ASIC) 920, is coupled to bus 910. The special purpose hardware is configured to perform operations not performed by processor 902 quickly enough for special purposes. Examples of application specific ICs include graphics accelerator cards for generating images for display 914, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 900 also includes one or more instances of a communications interface 970 coupled to bus 910. Communication interface 970 provides a one-way or two-way communication coupling to a variety of external devices that operate with their own processors, such as printers, scanners and external disks. In general the coupling is with a network link 978 that is connected to a local network 980 to which a variety of external devices with their own processors are connected. For example, communication interface 970 may be a parallel port or a serial port or a universal serial bus (USB) port on a personal computer. In some embodiments, communications interface 970 is an integrated services digital network (ISDN) card or a digital subscriber line (DSL) card or a telephone modem that provides an information communication connection to a corresponding type of telephone line. In some embodiments, a communication interface 970 is a cable modem that converts signals on bus 910 into signals for a communication connection over a coaxial cable or into optical signals for a communication connection over a fiber optic cable. As another example, communications interface 970 may be a local area network (LAN) card to provide a data communication connection to a compatible LAN, such as Ethernet. Wireless links may also be implemented. For wireless links, the communications interface 970 sends or receives or both sends and receives electrical, acoustic or electromagnetic signals, including infrared and optical signals, that carry information streams, such as digital data. For example, in wireless handheld devices, such as mobile telephones like cell phones, the communications interface 970 includes a radio band electromagnetic transmitter and receiver called a radio transceiver. In certain embodiments, the communications interface 970 enables connection to the communication network 107 for providing context attributes and informational links for media data to the UEs 101A . . . 101N.

The term “computer-readable medium” as used herein to refer to any medium that participates in providing information to processor 902, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 908. Volatile media include, for example, dynamic memory 904. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 920.

Network link 978 typically provides information communication using transmission media through one or more networks to other devices that use or process the information. For example, network link 978 may provide a connection through local network 980 to a host computer 982 or to equipment 984 operated by an Internet Service Provider (ISP). ISP equipment 984 in turn provides data communication services through the public, world-wide packet-switching communication network of networks now commonly referred to as the Internet 990.

A computer called a server host 992 connected to the Internet hosts a process that provides a service in response to information received over the Internet. For example, server host 992 hosts a process that provides information representing video data for presentation at display 914. It is contemplated that the components of system 900 can be deployed in various configurations within other computer systems, e.g., host 982 and server 992.

At least some embodiments of the invention are related to the use of computer system 900 for implementing some or all of the techniques described herein. According to one embodiment of the invention, those techniques are performed by computer system 900 in response to processor 902 executing one or more sequences of one or more processor instructions contained in memory 904. Such instructions, also called computer instructions, software and program code, may be read into memory 904 from another computer-readable medium such as storage device 908 or network link 978. Execution of the sequences of instructions contained in memory 904 causes processor 902 to perform one or more of the method steps described herein. In alternative embodiments, hardware, such as ASIC 920, may be used in place of or in combination with software to implement the invention. Thus, embodiments of the invention are not limited to any specific combination of hardware and software, unless otherwise explicitly stated herein.

The signals transmitted over network link 978 and other networks through communications interface 970, carry information to and from computer system 900. Computer system 900 can send and receive information, including program code, through the networks 980, 990 among others, through network link 978 and communications interface 970. In an example using the Internet 990, a server host 992 transmits program code for a particular application, requested by a message sent from computer 900, through Internet 990, ISP equipment 984, local network 980 and communications interface 970. The received code may be executed by processor 902 as it is received, or may be stored in memory 904 or in storage device 908 or other non-volatile storage for later execution, or both. In this manner, computer system 900 may obtain application program code in the form of signals on a carrier wave.

Various forms of computer readable media may be involved in carrying one or more sequence of instructions or data or both to processor 902 for execution. For example, instructions and data may initially be carried on a magnetic disk of a remote computer such as host 982. The remote computer loads the instructions and data into its dynamic memory and sends the instructions and data over a telephone line using a modem. A modem local to the computer system 900 receives the instructions and data on a telephone line and uses an infra-red transmitter to convert the instructions and data to a signal on an infra-red carrier wave serving as the network link 978. An infrared detector serving as communications interface 970 receives the instructions and data carried in the infrared signal and places information representing the instructions and data onto bus 910. Bus 910 carries the information to memory 904 from which processor 902 retrieves and executes the instructions using some of the data sent with the instructions. The instructions and data received in memory 904 may optionally be stored on storage device 908, either before or after execution by the processor 902.

FIG. 10 illustrates a chip set 1000 upon which an embodiment of the invention may be implemented. Chip set 1000 is programmed to provide context attributes and informational links for media data as described herein and includes, for instance, the processor and memory components described with respect to FIG. 9 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip. Chip set 1000, or a portion thereof, constitutes a means for performing one or more steps of providing context attributes and informational links for media data.

In one embodiment, the chip set 1000 includes a communication mechanism such as a bus 1001 for passing information among the components of the chip set 1000. A processor 1003 has connectivity to the bus 1001 to execute instructions and process information stored in, for example, a memory 1005. The processor 1003 may include one or more processing cores with each core configured to perform independently. A multi-core processor enables multiprocessing within a single physical package. Examples of a multi-core processor include two, four, eight, or greater numbers of processing cores. Alternatively or in addition, the processor 1003 may include one or more microprocessors configured in tandem via the bus 1001 to enable independent execution of instructions, pipelining, and multithreading. The processor 1003 may also be accompanied with one or more specialized components to perform certain processing functions and tasks such as one or more digital signal processors (DSP) 1007, or one or more application-specific integrated circuits (ASIC) 1009. A DSP 1007 typically is configured to process real-world signals (e.g., sound) in real time independently of the processor 1003. Similarly, an ASIC 1009 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 1003 and accompanying components have connectivity to the memory 1005 via the bus 1001. The memory 1005 includes both dynamic memory (e.g., RAM, magnetic disk, writable optical disk, etc.) and static memory (e.g., ROM, CD-ROM, etc.) for storing executable instructions that when executed perform the inventive steps described herein to provide context attributes and informational links for media data. The memory 1005 also stores the data associated with or generated by the execution of the inventive steps.

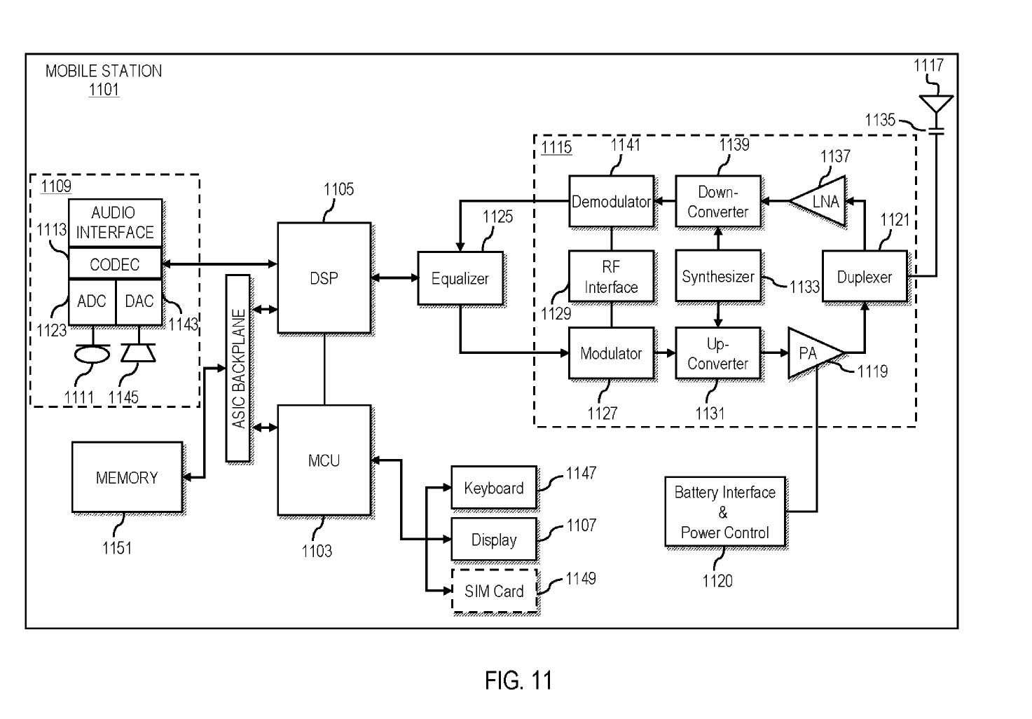

FIG. 11 is a diagram of exemplary components of a mobile terminal (e.g., handset) for communications, which is capable of operating in the system of FIG. 1, according to one embodiment. In some embodiments, mobile terminal 1101, or a portion thereof, constitutes a means for performing one or more steps of providing context attributes and informational links for media data. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 1103, a Digital Signal Processor (DSP) 1105, and a receiver/transmitter unit including a microphone gain control unit and a speaker gain control unit. A main display unit 1107 provides a display to the user in support of various applications and mobile terminal functions that perform or support the steps of providing context attributes and informational links for media data. The display 11 includes display circuitry configured to display at least a portion of a user interface of the mobile terminal (e.g., mobile telephone). Additionally, the display 1107 and display circuitry are configured to facilitate user control of at least some functions of the mobile terminal. An audio function circuitry 1109 includes a microphone 1111 and microphone amplifier that amplifies the speech signal output from the microphone 1111. The amplified speech signal output from the microphone 1111 is fed to a coder/decoder (CODEC) 1113.

A radio section 1115 amplifies power and converts frequency in order to communicate with a base station, which is included in a mobile communication system, via antenna 1117. The power amplifier (PA) 1119 and the transmitter/modulation circuitry are operationally responsive to the MCU 1103, with an output from the PA 1119 coupled to the duplexer 1121 or circulator or antenna switch, as known in the art. The PA 1119 also couples to a battery interface and power control unit 1120.

In use, a user of mobile terminal 1101 speaks into the microphone 1111 and his or her voice along with any detected background noise is converted into an analog voltage. The analog voltage is then converted into a digital signal through the Analog to Digital Converter (ADC) 1123. The control unit 1103 routes the digital signal into the DSP 1105 for processing therein, such as speech encoding, channel encoding, encrypting, and interleaving. In one embodiment, the processed voice signals are encoded, by units not separately shown, using a cellular transmission protocol such as global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like.

The encoded signals are then routed to an equalizer 1125 for compensation of any frequency-dependent impairments that occur during transmission though the air such as phase and amplitude distortion. After equalizing the bit stream, the modulator 1127 combines the signal with a RF signal generated in the RF interface 1129. The modulator 1127 generates a sine wave by way of frequency or phase modulation. In order to prepare the signal for transmission, an up-converter 1131 combines the sine wave output from the modulator 1127 with another sine wave generated by a synthesizer 1133 to achieve the desired frequency of transmission. The signal is then sent through a PA 1119 to increase the signal to an appropriate power level. In practical systems, the PA 1119 acts as a variable gain amplifier whose gain is controlled by the DSP 1105 from information received from a network base station. The signal is then filtered within the duplexer 1121 and optionally sent to an antenna coupler 1135 to match impedances to provide maximum power transfer. Finally, the signal is transmitted via antenna 1117 to a local base station. An automatic gain control (AGC) can be supplied to control the gain of the final stages of the receiver. The signals may be forwarded from there to a remote telephone which may be another cellular telephone, other mobile phone or a land-line connected to a Public Switched Telephone Network (PSTN), or other telephony networks.

Voice signals transmitted to the mobile terminal 1101 are received via antenna 1117 and immediately amplified by a low noise amplifier (LNA) 1137. A down-converter 1139 lowers the carrier frequency while the demodulator 1141 strips away the RF leaving only a digital bit stream. The signal then goes through the equalizer 1125 and is processed by the DSP 1105. A Digital to Analog Converter (DAC) 1143 converts the signal and the resulting output is transmitted to the user through the speaker 1145, all under control of a Main Control Unit (MCU) 1103—which can be implemented as a Central Processing Unit (CPU) (not shown).

The MCU 1103 receives various signals including input signals from the keyboard 1147. The keyboard 1147 and/or the MCU 1103 in combination with other user input components (e.g., the microphone 1111) comprise a user interface circuitry for managing user input. The MCU 1103 runs a user interface software to facilitate user control of at least some functions of the mobile terminal 1101 to provide context attributes and informational links for media data. The MCU 1103 also delivers a display command and a switch command to the display 1107 and to the speech output switching controller, respectively. Further, the MCU 1103 exchanges information with the DSP 1105 and can access an optionally incorporated SIM card 1149 and a memory 1151. In addition, the MCU 1103 executes various control functions required of the terminal. The DSP 1105 may, depending upon the implementation, perform any of a variety of conventional digital processing functions on the voice signals. Additionally, DSP 1105 determines the background noise level of the local environment from the signals detected by microphone 1111 and sets the gain of microphone 1111 to a level selected to compensate for the natural tendency of the user of the mobile terminal 1101.

The CODEC 1113 includes the ADC 1123 and DAC 1143. The memory 1151 stores various data including call incoming tone data and is capable of storing other data including music data received via, e.g., the global Internet. The software module could reside in RAM memory, flash memory, registers, or any other form of writable storage medium known in the art. The memory device 1151 may be, but not limited to, a single memory, CD, DVD, ROM, RAM, EEPROM, optical storage, or any other non-volatile storage medium capable of storing digital data.

An optionally incorporated SIM card 1149 carries, for instance, important information, such as the cellular phone number, the carrier supplying service, subscription details, and security information. The SIM card 1149 serves primarily to identify the mobile terminal 1101 on a radio network. The card 1149 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

1-17. (canceled)

18. A method comprising:
receiving media data on an apparatus;
receiving one or more context attributes related to the apparatus or accessed by the apparatus;
determining whether the one or more context attributes relate to the received media data; and
causing, at least in part, display of the received media data with the one or more context attributes that are determined to relate to the received media data.

19. A method of claim 18, wherein the received media data is a communication message, and further comprising:
formulating a response to the communication message using, at least in part, the one or more context attributes that are determined to relate to the received media data.

20. A method of claim 18, further comprising:
determining one or more informational links corresponding to the one or more context attributes that are determined to relate to the received media data; and
causing, at least in part, display of the one or more informational links with the received media data and the one or more context attributes that are determined to relate to the received media data.

21. A method of claim 20, wherein the one or more informational links are advertisements corresponding to the one or more context attributes that are determined to relate to the received media data.

22. A method of claim 20, wherein the one or more informational links are point of interest locations on a mapping application corresponding to the one or more context attributes that are determined to relate to the received media data.

23. A method of any of claim 18, wherein the one or more context attributes include data from a sensor of the apparatus, data from a remote service provider, and/or data input via a user interface of the apparatus.

24. A method of any of claim 18, wherein the received media data includes one or more keywords and/or keyphrases, and wherein the determination of whether the one or more context attributes relate to the received media data includes determining whether the one or more context attributes relate to the one or more keywords and/or keyphrases, and further comprising:
causing, at least in part, highlighted display of the one or more keywords and/or keyphrases having one or more context attributes related thereto.

25. A method of claim 24, wherein the one or more context attributes are caused to be displayed upon selection of the highlighted display of the one or more keywords and/or keyphrases.

26. An apparatus comprising:
at least one processor; and
at least one memory including computer program code,
the at least one memory and the computer program code configured to, with the at least one processor, cause the apparatus to perform at least the following, receive media data on the apparatus;
receive one or more context attributes related to the apparatus or accessed by the apparatus;
determine whether the one or more context attributes relate to the received media data; and
cause, at least in part, display of the received media data with the one or more context attributes that are determined to relate to the received media data.

27. The apparatus of claim 26, wherein the received media data is a communication message, and wherein the apparatus is further caused, at least in part, to:
formulate an automated response to the communication message using the one or more context attributes that are determined to relate to the received media data.

28. The apparatus of claim 26, wherein the apparatus is further caused, at least in part, to:
determine one or more informational links corresponding to the one or more context attributes that are determined to relate to the received media data; and
cause, at least in part, display of the one or more informational links with the received media data and the one or more context attributes that are determined to relate to the received media data.

29. The apparatus of claim 28, wherein the one or more informational links are advertisements corresponding to the one or more context attributes that are determined to relate to the received media data.

30. The apparatus of claim 28, wherein the one or more informational links are point of interest locations on a mapping application corresponding to the one or more context attributes that are determined to relate to the received media data.

31. The apparatus of claim 26, wherein the one or more context attributes include data from a sensor of the apparatus, data from a remote service provider, and/or data input via a user interface of the apparatus.

32. The apparatus of claim 26, wherein the received media data includes one or more keywords and/or keyphrases, wherein the determination of whether the one or more context attributes relate to the received media data includes determining whether the one or more context attributes relate to the one or more keywords and/or keyphrases, and wherein the apparatus is further caused, at least in part, to:
cause, at least in part, highlighted display of the one or more keywords and/or keyphrases having one or more context attributes related thereto.

33. The apparatus of claim 32, wherein the one or more context attributes are caused to be displayed upon selection of the highlighted display of the one or more keywords and/or keyphrases.

34. The apparatus of claim 26, wherein the apparatus is a mobile phone further comprising:
user interface circuitry and user interface software configured to facilitate user control of at least some functions of the mobile phone through use of a display and configured to respond to user input; and
a display and display circuitry configured to display at least a portion of a user interface of the mobile phone, the display and display circuitry configured to facilitate user control of at least some functions of the mobile phone.

35. A computer-readable storage medium carrying one or more sequences of one or more instructions which, when executed by one or more processors, cause an apparatus to at least perform the following steps:
receiving media data on an apparatus;
receiving one or more context attributes related to the apparatus or accessed by the apparatus;
determining whether the one or more context attributes relate to the received media data; and
causing, at least in part, display of the received media data with the one or more context attributes that are determined to relate to the received media data.

36. A method comprising:
receiving media data on an apparatus;
parsing the received media data into one or more structured elements;
determining one or more informational links that relate to the one or more structured elements of the received media data; and
causing, at least in part, display of the received media data with the one or more informational links that are determined to relate to the one or more structured elements.

37. A method of claim 36, further comprising:
receiving one or more context attributes related to the apparatus or accessed by the apparatus; and
determining whether the one or more context attributes relate to the one or more structured elements,
wherein the one or more informational links caused to be displayed are determined to relate to the one or more structured elements and to relate to the one or more context attribute.
